(19) United States
(12) Patent Application Publication
(10) Pub. No.: US 2014/0231617 A1
(43) Pub. Date: Aug. 21, 2014

(54) SUSPENSION MOULDS

(71) Applicant: Wusheng Wang, Shanghai (CN)

(72) Inventor: Wusheng Wang, Shanghai (CN)

(73) Assignee: EMPIRE TECHNOLOGY DEVELOPMENT LLC, Wilmington, DE (US)

(21) Appl. No.: 14/241,844

(22) PCT Filed: Sep. 26, 2011
(86) PCT No.: PCT/CN2011/080160

§ 371 Date: Apr. 3, 2014

(51) Int. Cl. B29C 33/30

(52) U.S. Cl. CPC B29C 33/30
USPC 249/205

(57) ABSTRACT

The present disclosure generally describes a mould support structure. In some embodiments, a mould support structure can include a supporting member, a suspending member connected to the supporting member, and a moulding board connected to the suspending member. The supporting member can be configured to support the moulding board via the suspending member while the supporting member is positioned at least partially above the moulding board.

### BACKGROUND

In order to employ a curable material for construction purposes, one generally employs some type of formwork to hold the curable material in place while it cures. Once the curable material has been poured into the formwork and has set, (“cured”), the form is typically removed to expose the cured product.

There are many different types of formworks or moulds, including traditional timber formwork, engineered formwork systems built of prefabricated modules, re-usable plastic formwork, permanent insulated formwork or mould, and stay-in-place structural formwork or mould systems.

Cast-in-situ construction methods are suitable for reducing the amount of heavy machinery and high technology needed for the mould. Current cast-in-situ moulds for buildings appear to adopt the method of using steel tubes positioned underneath the moulding boards (onto which the curable material is poured) to support the curable material in place until it has cured.

### SUMMARY

The present disclosure provides for mould support structures and methods for preparing and/or using a mould and/or mould support structure for casting a curable material. In some embodiments, by employing a mould structure that utilizes suspension principles for supporting the moulding board, the cost and efficiency of cast-in-situ formwork can be greatly improved.

In some embodiments, the present disclosure provides a mould support structure that includes a supporting member, a suspending member connected to the supporting member, and a moulding board connected to the suspending member. The supporting member is configured to support the moulding board via the suspending member while the supporting member is positioned at least partially above the moulding board. In some embodiments, the supporting member includes an arced support beam.

In some embodiments, the present disclosure provides a method for preparing a mould for casting a curable material. The method includes providing a moulding board, providing a supporting member positioned above the moulding board, and suspending the moulding board from the supporting member. In some embodiments, the curable material includes concrete.

In some embodiments, the present disclosure provides a kit including a concrete moulding board, a suspending member, and a supporting member. The supporting member can be configured to suspend the moulding board from the suspending member.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an example of a schematic diagram of a mould support structure.

FIGS. 2A-2G illustrate an example of operations for preparing a mould.

FIG. 3 illustrates a flow diagram of an illustrative embodiment of a method for preparing a mould.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The technologies and embodiments described herein relate generally to formworks (or “forms”) and mould support structures. In some embodiments, the support structure can include a supporting member, a suspending member connected to the supporting member, and a moulding board connected to the suspending member. In some embodiments, the supporting member can be positioned at least partially above the moulding board while providing support to the moulding board via the suspending member.

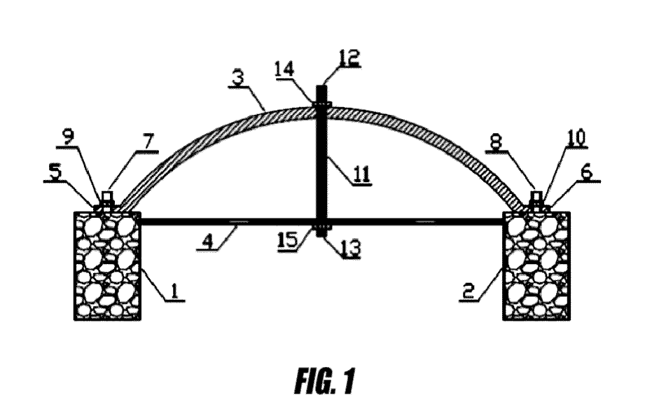

FIG. 1 illustrates an example of a schematic diagram of a mould support structure. In some embodiments, the mould support structure can include one or more supporting members 3. In some embodiments, the supporting members 3 can be an arced support beam. For example, the shape of the supporting members 3 can be arched or otherwise curved. In some embodiments, the supporting members 3 can have a first arm and a second arm (and optionally more arms), in which the first arm and the second arm are connected to each other and form an angle of more than 180 degrees therebetween (e.g., the arms can form a bipod type arrangement). In some embodiments, the supporting members 3 can have a first arm and a second arm in which the first arm and the second arm are connected to each other (e.g., at a vertex) and form an angle of more than 180 degrees therebetween (where the angle values are “positive angles,” i.e., they are measured in the anticlockwise direction). In some embodiments, the first arm can be linear and/or the second arm can be linear. In certain embodiments, the first arm can be connected to the second arm via a spanning member (not shown in FIG. 1). In some embodiments, the supporting member 3 can be made of suitable material known in the art, such as steel, aluminum, concrete (such as a concrete rod), or some combination thereof.

As illustrated in FIG. 1, the supporting members 3 can have the shape of an arc, which in some embodiments, can be fixed between two or more columns, e.g., a column 1 and a column 2. For example, to fix the supporting member 3, a left end 5 of the supporting member 3 can be configured so as to allow a screw or bolt 7 to pass through it into the column 1 and it can be fastened by a nut 9. Similarly, in some embodiments, a right end 6 of the supporting member 3 can be configured so as to allow a screw or bolt 8 to pass through it into the column 2 and it can be fastened by a nut 10. In some embodiments, the supporting members 3 can be a multiple number of bars connected to two or more columns.

In some embodiments, the mould support structure also includes a suspending member 11, which can be connected to the supporting member 3. In some embodiments, the suspending member 11 can include a threaded rod. In the illustrated embodiment, the suspending member 11 perpendicularly extends from a peak of the suspending member 3 to a moulding board 4. In some embodiments, the suspending member is not connected to the peak of the supporting member (and the supporting member need not have a “peak” in all embodiments) and/or is not connected to the center of moulding board. In some embodiments, the supporting member 3 includes a hole into which the suspending member 11 may be inserted. The suspending member 11 can include a retaining structure 14, e.g., a nut, which can be sized so as to prevent the suspending member 11 from passing completely through the hole. The nut 14 can fasten the upper end of the suspending member 11 to the supporting members 3. In some embodiments, the nut 14 can be configured to threadably engage the suspending member 11. In some embodiments, the suspending member 11 can be detachably connected to the supporting members 3. In some embodiments, the retaining structure includes two or more nuts, washer, locking washer, a locking nut, or other structure so that it will not be inclined to come unfastened when the suspending member is rotated.

In some embodiments, the mould support structure can include a moulding board 4, which can be positioned between the column 1 and column 2. In some embodiments, the moulding board 4 may be positioned perpendicular to the suspending member 11. In the illustrated embodiment, the supporting members 3 are positioned above or at least partially above the moulding board 4. The moulding board 4 can be made of a suitable material known in the art, such as steel, plastic, wood, aluminum, cardboard, concrete (such as a concrete rod) and any combination thereof.

In some embodiments, the moulding board 4 can include a hole into which the suspending member 11 can be inserted. In some embodiments, the lower end of the suspending member 11 can pass through the hole of the moulding board 4 and the suspending member 11 can be detachably connected to the moulding board 4. In some embodiments, a retaining structure 15, e.g., a nut, can be sized so as to fasten the lower end of the suspending member 11 to the moulding board 4. In some embodiments, more than one nut can be employed. In some embodiments, a washer a locking washer, a locking nut, or other structure can be employed in order to reduce the chance that the retaining structure will inadvertently disengage from the suspending member 11 when the device is in use.

In some embodiments, the suspending member 11 can be fastened to the moulding board 4 so as to prevent the moulding board 4 from falling down or sagging when a curable material (e.g., concrete, resin, plaster, plastic, asphalt, fiber reinforced materials, loess and mud based materials) is poured onto the moulding board 4. Application of the curable material can result in an increase in the weight applied to the moulding board 4 and can generate a downward force on the suspending member 11 connected to it. In some embodiments, the suspending member 11 can transfer the downward force to the supporting member 3 and, due to the shape of the supporting member 3, the force can be transferred to column 1 and column 2. In some embodiments, the column 1 and column 2 can bear a pressing force. As such, the weight on the moulding board 4 can be transferred into pressing forces onto column 1 and column 2

In some embodiments, a second suspending member (not shown) can be attached to the supporting members 3 and to the moulding board 4. In some embodiments, a multiple number of suspending members can be attached to the supporting member 3 and to the moulding board 4, where the number of suspending members 11 can be related to the width of the moulding board 4. In some embodiments, the wider the width, the more suspending members can be used. In some embodiments, additional suspending members can be used in light of the flexibility of the moulding board and/or weight of the material to be added. In some embodiments, additional suspending members can be employed when the material to be cured will take a relatively long period of time (for added strength) and/or when greater stability and/or balance is desired for the form. For example, when there is concern that a moulding board, such as the moulding board 4, may move (e.g., from the application of the curable material or simply over time), three or more suspending members (e.g., 4, 5, 6, 7, 8, 9, 10, 15, 20, 25, 30, 40, or 50 suspending members can be employed, including ranges defined between any two of the preceding values and ranges greater than any one of the preceding values) can be useful. In some embodiments, when more than one suspending member 11 is employed, they each may attach to the same point on the supporting member 3, the same point on the moulding board 4, different points on the supporting member 3, to a single main suspending member, and/or different points on the moulding board. Thus, where greater stability is desired, the suspending members 11 can be placed at distal ends or corners of the moulding board and at points distal to the apex of the supporting member 3.

In some embodiments, the suspending members 11 and/or the supporting members 3 can be made of cables, line rods, and other structures known in the art. In certain embodiments, the supporting member 3 can include a steel cable, and the suspending member 11 can include a steel cable. The moulding board 4 can be moved when the tension or length of the cable of the supporting member 3 can be adjusted.

In some embodiments, the moulding board 4 can be made from a continuous surface (e.g., a sheet of metal or wood). In some embodiments, the moulding board can be made of a screen or cloth, as long as it is solid enough to retain the curable material until it has cured. In embodiments in which the moulding board is flexible, in some embodiments, there can be an outer frame configured to provide structural support to the outer edges of the moulding board. As is clear from these embodiments, the term “moulding board” is not limited to wooden structures.

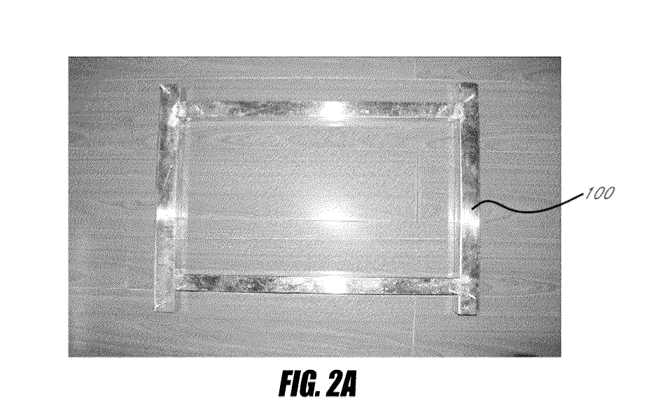

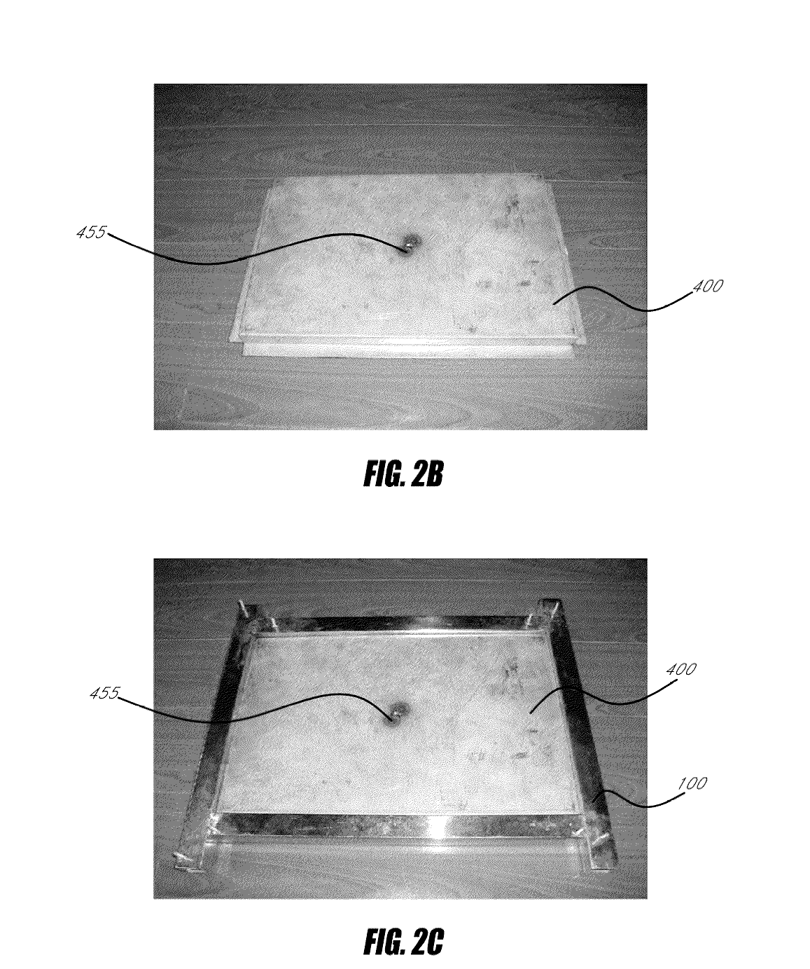

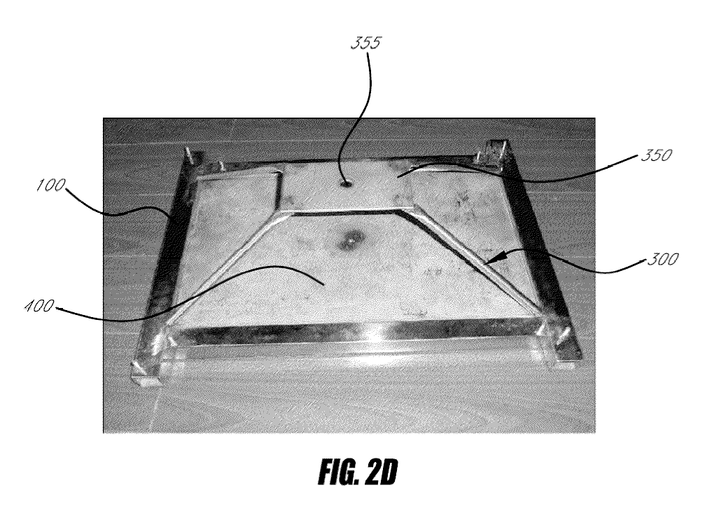

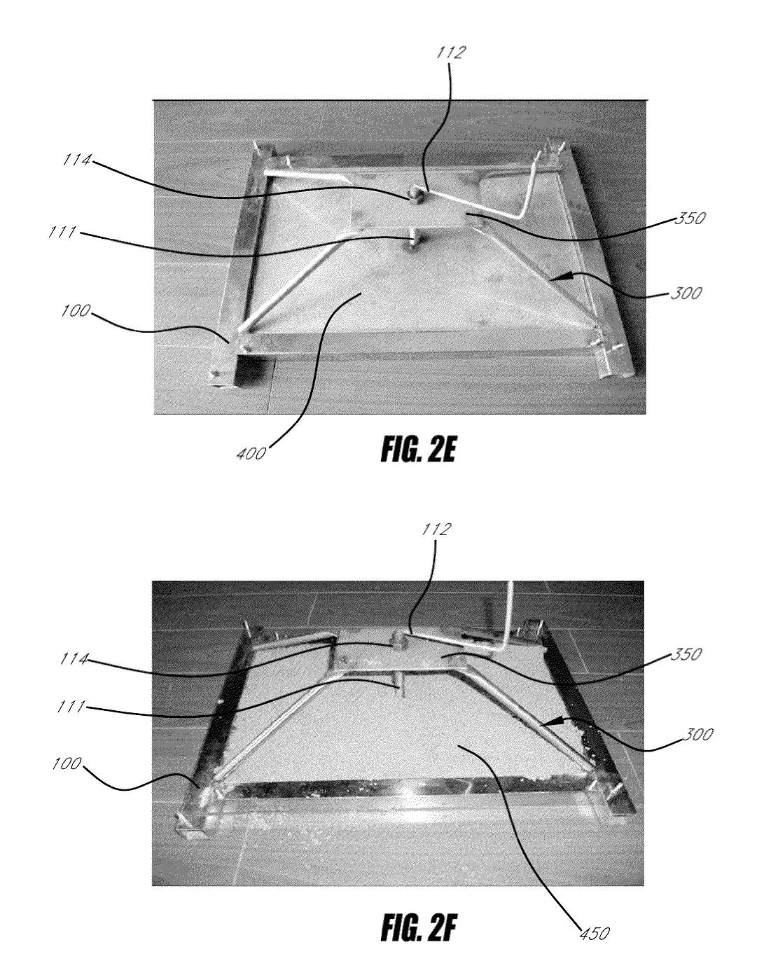

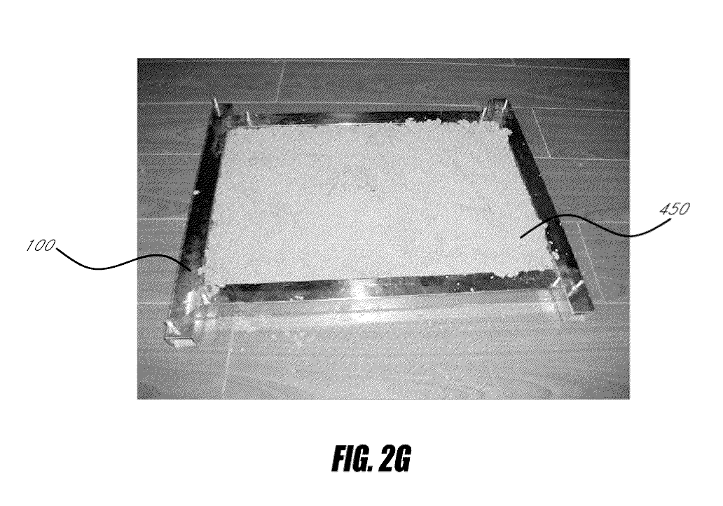

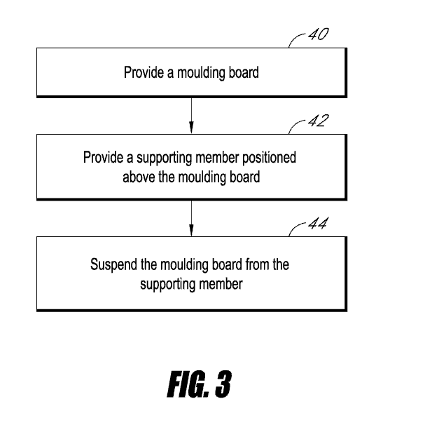

FIGS. 2A-2H illustrate an example of operations for preparing a mould. In FIG. 2A, an embodiment involving beams (represented by 100) of a building is provided. The beams 100 can form a rectangular fixed frame or structure, as illustrated in FIG. 2A. The beams 100 can be made of materials such as wood, plastic, aluminum, steel, or other suitable materials known in the art. In some embodiments, the rectangle formed by the frame in FIG. 2A can be representative of a hole which one wishes to fill with a curable material.

In FIG. 2B, an embodiment of a cast-in-situ moulding board 400 is provided. The moulding board 400 can be dimensioned so as to fit between and, optionally, in contact with the beams 100, as illustrated in FIG. 2C. In some embodiments, the moulding board 400 can have outwardly extending tabs configured to contact the beams 100. In some embodiments, the moulding board 400 can be detachably connected to the beams 100.

In FIG. 2D, a supporting member 300 is provided and positioned above the moulding board 400. The supporting member 300 can include two arched bars. In the depicted embodiment, there are four arched bars (or arms). In the depicted embodiment, the arms of the supporting member 300 are positioned to be at each of four corners formed by the beams 100. In some embodiments, the arms of the supporting member 300 can be detachably connected to the beams 100. Additionally, the supporting member 300 can include a surface or spanning member 350 connecting the two arched bars together. The plane of the spanning member 350 can be above the plane of the moulding board 400. As illustrated in FIG. 2D, the spanning member 350 can, in some embodiments connect the two arms to form the supporting member 300. In some embodiments, the spanning member 350 can also include a hole 355, and the hole 355 can be above and directly aligned or alignable with a hole 455 in the moulding board 400. In some embodiments, the hole 355 can be part of a supporting member 300 that lacks a spanning member 350.

FIG. 2E illustrates an embodiment in which a suspending member 111 has been inserted through the hole 355 and the hole 455. The lower end of the suspending member 111 can be fastened to the moulding board 400 by a nut (or other retaining structure, not shown) under the moulding board 400. In some embodiments, the retaining structure can threadably engage the lower end of the suspending member 111. This can allow the moulding board 400 to be suspended from the supporting member 300. In some embodiments, the suspending member can be magnetically connected to the moulding board. In some embodiments, the suspending member can be adhered to the moulding board. In some embodiments, the suspending member can be welded to the moulding board. In some embodiments, the suspending member can be rotatably connected to the moulding board, such that the suspending member can be rotated while the moulding board is serving as a base for the curable material.

In some embodiments, the moulding board 400 can be connected to the suspending member 111 via a rebar connector or a single use/disposable/cleavable connector. In some embodiments, the rebar connector can be sized so as to at least be partially exposed after concrete has been applied to the moulding board 400, thereby allowing the rebar to be cut, freeing the suspending member from the cured material. In some embodiments, the upper end of the suspending member 111 can be fastened to the supporting member 300 by a retaining member or nut 114 over the spanning member 350, which can threadably engage the upper end of the suspending member 111.

In some embodiments, the suspending member 111 can be rotatable and can further include a crank 112 to facilitate rotation by a user. In some embodiments, when the suspending member 111 is rotated in a first direction, e.g., clockwise, the suspending member 111 applies a force on the moulding board 400 in a second direction, e.g., upwards. In some embodiments, when the suspending member 11 is rotated in a direction opposite the first direction, e.g., counterclockwise, the suspending member 111 applies a force on the moulding board in a third direction, e.g., downwards. In some embodiments, one or more cables and pulleys can be employed as the suspending member, and raising and lowering the moulding board can be achieved by taking in or letting out cable passing through the one or more pulleys. In some embodiments, a geared system can be employed so as to allow the moulding board to be raised or lowered. In some embodiments, a spring or tension system can be employed as the suspending member, and the tension can be changed so as to raise and/or lower the moulding board. In some embodiments, the position of the moulding board and/or length of the suspending member can be fixed or static, and need not be configured for being raised or lowered.

As shown in FIG. 2F, a curable material, such as concrete, can be poured and casted on top of the moulding board 400. To sustain the weight on the moulding board 400 or to alter the elevation of the moulding board 400, the moulding board 400 can be tensioned by rotating the suspending member 111 in the first direction, e.g., clockwise. As the force of the concrete is applied to the moulding board 400, the suspending member 111 that can be connected to the supporting member 300 and the moulding board 400 can be configured to distribute the force applied from the moulding board 400 to the supporting member 300. The suspending member 111 can exert a tensile force that holds the moulding board 400 upwards and in place.

FIG. 2G illustrates some embodiments in which the curable material has been allowed to cure to form a self-supporting structure 450. As shown, in some embodiments, after the curable material has set, the suspending member 111 can be released from the moulding board 400 by rotating the suspending member 111 in a direction counter to the first direction, e.g., counterclockwise. Furthermore, the supporting member 300 and the moulding board 400 can be removed, leaving the self-supporting structure 450 in place between the columns and beams 100.

In some embodiments, at least a part of the suspending member 111 can be removed from the self-supporting structure 450. The suspending member 111 can be separated into at least two parts, in which a first part of the suspending member 111 can be embedded within the self-supporting structure 450 and a second part of the suspending member 111 can be connected to the self-supporting structure 450. In some embodiments, a shell or casing may be placed around the lower section of the suspending member 111, so as to protect the suspending member from being immobilized in the cured form of the curable material. In some embodiments, the shell or casing can include paper, tape, plastic, wax paper, aluminum foil, lubricating oil (such as cooking oil, motor oil, asphalt) etc. In some embodiments, an additional form may be placed around the suspending member, so as to prevent the curable material from adhering to the suspending member. In some embodiments, the suspending member may be coated in a lubricant or cure resistant substance, so that the curable material in immediate contact with the suspending member will not adhere to the suspending member. In some embodiments, a sharp blow to the suspending member can be sufficient to loosen the suspending member from the curable material.

FIG. 3 illustrates a flow diagram of an illustrative embodiment of a method for preparing a mould. In some embodiments, the process begins at block 40, “Provide a moulding board”, where a moulding board can be provided. The process continues at block 42, “Provide a supporting member positioned above the moulding board”, where a supporting member that can provide support to the moulding board when it is positioned above the moulding board can be provided. The process further continues at block 44, “Suspend the moulding board from the supporting member”, where the moulding board can be suspended from the supporting member. This can be achieved via the use of a suspending member. In some embodiments, the process provides for efficient installation because the supporting member can be provided from above to at least partially support the moulding board. In some embodiments, this system can be employed in locations or situations where it can be difficult to build a support underneath the moulding board.

In some embodiments, the method and/or device employs an arced support as the supporting member. In some embodiments, suspending the moulding board includes extending a suspending member vertically from a peak of the arced support to the moulding board. In some embodiments, suspending the moulding board from the supporting member involves threadably engaging the suspending member with the moulding board via a suspending member. In some embodiments, one can further apply tension to the moulding board by rotating the suspending member in a first direction. In some embodiments, one further applies a curable material on top of the moulding board. In some embodiments, the curable material is allowed to cure to a self-supporting structure. In some embodiments, the method includes releasing the suspending member from the moulding board by rotating the suspending member in a second direction. In some embodiments, the method includes removing at least a part of the suspending member from the self-supporting structure. In some embodiments, the method includes the step of separating the suspending member into at least two parts. The first part of the suspending member can remain embedded within the self-supporting structure and a second part of the suspending member can be and/or was connected to the self-supporting structure (e.g., prior to it the section of the suspending member being separated or cut into two or more pieces). In some embodiments, the curable material includes concrete. In some embodiments, the supporting member can be connected to a surface. In some embodiments, a plane of the surface can be above a plane of the moulding board.

In some embodiments, a first layer of a curable material can be applied to the moulding board and allowed to cure or at least partially cure before a second or additional layer of curable material is applied. Thus, in situations where the supporting member, suspending members, and or moulding board might not be strong enough to adequately support the curable material as it cures, rounds of application of the curable material can be employed so that the weight can be supported in part by the previously applied and partially (or fully) cured layer. In some embodiments, rebar or other reinforcing materials can be placed in and/or with the curable material. One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In some embodiments, the suspending member and the supporting member can be one in the same structures. For example, in some embodiments, a single cable can be attached to walls on either side of and above a hole in a floor. When the moulding board is positioned within the hole, the cable can be pulled down such that the cable forms a “V” shape, with the bottom of the V forming the point of contact with the molding board and the top of each arm of the V forming an attachment point to one or more walls.

In some embodiments, a kit is provided. The kit can include a concrete moulding board, a suspending member, and a supporting member. In some embodiments, the suspending member can be configured to suspend the moulding board from the suspending member. In some embodiments, the kit can also include a rebar connector. The connector can be configured to connect the moulding board to the suspending member. In some embodiments, the connector can be sized so as to at least be partially exposed after concrete has been applied to the concrete moulding board.

In some embodiments, the suspending member is, or is part of, a cable, which can be metal, plastic, threaded, braided, etc. In some embodiments, the suspending member is, or is part of, a chain, a cable, a rod, a rope, a block, a tube, concrete, rods, tubes, I-beam, or other components. In some embodiments, the suspending member can be rigid and resists stretching. In some the suspending member can be flexible. In some embodiments, the suspending member can be stretchable. In embodiments in which the suspending member can be flexible or stretchable, the deformations from the resting position can either be inconsequential to the use of the device, or can be taken into account when the device is used.

In some embodiments, the suspending member can be moveable. In some embodiments, the suspending member can be rotatable. In embodiments in which rotation of the suspending member can raise and/or lower the moulding board, the location of movement can occur at one or more locations. In some embodiments, the device can be configured so that rotation of the suspending member moves the suspending member relative to the moulding board. In some embodiments, the device can be configured so that rotation of the suspending member moves the suspending member relative to the supporting member. In some embodiments, the device can be configured so that rotation of the suspending member moves the suspending member relative to the supporting member and moves the suspending member relative to the moulding board. As will be appreciated by those of skill in the art, in light of the present disclosure, these embodiments can be achieved in a variety of ways, for example, having variously threaded ends on the suspending member and the appropriate retaining members on the ends. In some embodiments, fixing the retaining members relative to the supporting member and/or the moulding board can also allow for various options for moving the various parts relative to one another. In some embodiments, adjusting the tension on the suspending member can provide movement of the moulding board.

In some embodiments, the supporting member includes one or more structures that can at least partially support a moulding board and/or curable material. In some embodiments, the supporting member includes a rod (including, for example, rebar), a beam, a tube, a chain, a steel structure, a cable, a rope, or other load bearing structure. In some embodiments, the supporting member can include any combination of the preceding structures. As noted above, in some embodiments, the supporting member can be arced. In some embodiments, the arc can been angular, and thus can include more than one segments (e.g., which can denote more than one arm). In some embodiments, the segmented arc includes 2, 3, 4, 5, 6, 7, 8, 9, 10, 11, 12, 13, 14, 15, 20, 25 or more segments in a single run of the supporting member, including ranges greater than any of the preceding values and defined between any of two of the preceding values. In some embodiments, more than one supporting member can be employed, for example 2, 3, 4, 5, 6, 7, 8, 9, 10, 11, 12, 13, 14, 15, 20, or more supporting members, including ranges greater than any of the preceding values and defined between any of two of the preceding values can be employed. In some embodiments, a single supporting member can include 1, 2, 3, 4, 5, 6, 7, 8, 9, 10, 11, 12, 13, 14, 15, 20, 25, 30, 35, 40, 50 or more arms, including ranges greater than any of the preceding values and defined between any of two of the preceding values. It is noted that an “arm” denotes a structure that connects the supporting member to another structure, such as the column. A “segment” denotes a specific structural part, independent of it functional purpose or relationship. Thus, in FIG. 2D, the straight rods can be characterized as arms and/or segments, although this is not necessarily the case in all situations. For example, the spanning member 350 can be characterized as a segment, but would not be characterized as an arm. Similarly, if the supporting member 3 in FIG. 1 were a continuous arc it would be a single segment, although it could still be characterized as having 2 arms. In some embodiments, the structure can be other than an arc, for example, the shape of Π or other linear load bearing structure. In some embodiments, the framework is of cement. In some embodiments, the framework can be of one piece or can be an assembly of multiple pieces, such as two legs and a platform on top of the two legs. In some embodiments, the supporting member can be made of steel.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, compounds, compositions or systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A mould support structure comprising:
a supporting member;
a suspending member connected to the supporting member; and
a moulding board connected to the suspending member, wherein the supporting member is configured to support the moulding board via the suspending member while the supporting member is positioned at least partially above the moulding board.

2. The mould support structure of claim 1, wherein the supporting member comprises an arced support beam.

3. The mould support structure of claim 1, wherein the supporting member comprises:
a first arm; and
a second arm, wherein the first arm is connected to the second arm, and wherein an angle formed between the first arm and second arm is more than 180 degrees.

4. The mould support structure of claim 3, wherein the first arm is linear and the second arm is linear.

5. The mould support structure of claim 4, wherein the first arm is connected to the second arm via a spanning member.

6. The mould support structure of claim 2, wherein the suspending member perpendicularly extends from a peak of the arced support to the moulding board.

7. (canceled)

8. (canceled)

9. The mould support structure of claim 1, wherein the supporting member comprises a hole, into which the suspending member can be inserted, and wherein the suspending member further comprises a retaining structure that is sized so as to prevent the suspending member from passing completely through the hole.

10. (canceled)

11. (canceled)

12. (canceled)

13. (canceled)

14. (canceled)

15. The mould support structure of claim 1, wherein the suspending member comprises a threaded rod.

16. (canceled)

17. (canceled)

18. The mould support structure of claim 1, wherein the suspending member is rotatable.

19. (canceled)

20. (canceled)

21. A method for preparing a mould for casting a curable material, said method comprising:
providing a moulding board;
providing a supporting member positioned above the moulding board; and
suspending the moulding board from the supporting member.

22. The method of claim 21, wherein the supporting member comprises an arced support.

23. The method of claim 22, wherein suspending the moulding board comprises extending a suspending member vertically from a peak of the arced support to the moulding board.

24. The method of claim 23, wherein suspending the moulding board from the supporting member comprises threadably engaging the suspending member with the moulding board via a suspending member.

25. The method of claim 24, further comprising tensioning the moulding board by rotating the suspending member in a first direction.

26. The method of claim 25, further comprising applying a curable material on top of the moulding board.

27. The method of claim 26, further comprising allowing the curable material to cure to a self-supporting structure.

28. The method of claim 27, further comprising releasing the suspending member from the moulding board by rotating the suspending member in a second direction.

29. (canceled)

30. The method of claim 28, further comprising the step of separating the suspending member into at least two parts, wherein a first part of the suspending member is embedded within the self-supporting structure and a second part of the suspending member is connected to the self-supporting structure.

31. (canceled)

32. The method of claim 21, further comprising connecting the supporting member to a surface.

33. The method of claim 32, wherein a plane of the surface is above a plane of the moulding board.

34. A kit comprising:
a concrete moulding board;
a suspending member; and
a supporting member, wherein the suspending member is configured to suspend the moulding board from the suspending member.

35. (canceled)
